(19) United States
(12) Patent Application Publication
(10) Pub. No.: US 2020/0093574 A1
(43) Pub. Date: Mar. 26, 2020

(54) Apparatuses and Methods for Pre-Conditioning Dentition Extraction Site for Implantation

(71) Applicant: Advanced Orthodontics and Education Association, LLC, Ossining, NY (US)

(72) Inventors: Bryce A. WAY, San Jose, CA (US); Richard JOHNSON, Briarcliff Manor, NY (US)

(73) Assignee: Advanced Orthodontics and Education Association, LLC, Ossining, NY (US)

(21) Appl. No.: 16/139,727

(22) Filed: Sep. 24, 2018

(51) Int. Cl. A61C 7/00; A61C 7/08

(52) U.S. Cl. CPC A61C 7/008; A61C 8/0006; A61C 7/08

(57) ABSTRACT

Embodiments of the present disclosure are directed to apparatuses and methods for pre-conditioning an extraction site for dental implantation. In one implementation, a method for pre-conditioning an extraction site for dental implantation includes providing a vibrational dental device configured to vibrate at a frequency higher than about 20 Hz. The method further includes providing instructions for mechanically vibrating, using the vibrational dental device, a tooth at the extraction site for about a predetermined period of time daily over a treatment period before extracting the tooth. The mechanical vibration may prepare the extraction site to be in a healthier condition for receiving an implant.

### CROSS-REFERENCE TO RELATED APPLICATIONS

This application is related to U.S. patent application Ser. No. 15/672,981, filed Aug. 9, 2017, which is a continuation-in-part of PCT/US2017/019767, U.S. patent application Ser. No. 15/875,779, filed Jan. 19, 2018, which is a continuation-in-part of U.S. patent application Ser. No. 15/672,981, filed Aug. 9, 2017, U.S. patent application Ser. No. 16/139,268, filed Sep. 24, 2018, entitled “Systems and Methods for Reducing Root Resorption in Orthodontic Treatment,” and U.S. patent application Ser. No. 16/139,444, filed Sep. 24, 2018, entitled “Apparatuses and Methods for Preservation of Loose Dentition,” all of which are incorporated by reference in their entirety.

### BACKGROUND

### Technical Field

The present disclosure generally relates to dental devices and methods. More particularly, and without limitation, the disclosed embodiments relate to devices, systems, and methods for pre-conditioning a dentition extraction site for dental implantation.

### Background Description

Dental injuries, infections, or orthodontic forces can cause damage to the teeth, such as root resorption, resulting in increased tooth mobility. Loose teeth can make it difficult and painful to eat and talk, and can progress and eventually need to be extracted. Upon extraction of a loose tooth, an implant can be surgically placed in the space created in the bone. After the implant, e.g., a post, integrates to the bone, it serves as a new “root” for a crown that will replace the extracted tooth.

For an implant to be successful, there needs to be adequate bone of sufficient strength in the jaw to hold and support the implant. If there is not enough bone or the quality of the bone is not sufficient, bone augmentation or bone grafting may be performed before the implant is placed, which may take a few months and increase the overall implant treatment time. The healing period after the implant surgery may last for a few months or longer, and discomfort during the healing period may include swelling, bruising, minor bleeding, and pain. The surgical procedures and dental care for implantation are extensive and expansive, and not all implants can survive. Therefore, apparatuses and methods are needed to reduce the overall treatment time and improve the results of dental implantation.

### SUMMARY

The embodiments of the present disclosure include apparatuses and methods for pre-conditioning a dentition extraction site for dental implantation with mechanical vibration. Advantageously, the exemplary embodiments may pre-condition the bones and/or soft tissue around the tooth to be extracted to be more suitable for later post-extraction implant placement, thereby improving the results of implantation.

According to an exemplary embodiment of the present disclosure, a method for pre-conditioning an extraction site for dental implantation is described. The method may include providing a vibrational dental device configured to vibrate at a frequency between about 20 Hz and about 250 Hz, such as at a frequency higher than about 80 Hz. The method may further include providing instructions for mechanically vibrating, using the vibrational dental device, a tooth at the extraction site for about a predetermined period of time daily over a treatment period before extracting the tooth. The mechanical vibration may prepare the extraction site to be in a healthier condition for receiving an implant.

According to another exemplary embodiment of the present disclosure, a method for pre-conditioning an extraction site for dental implantation is described. The method may include obtaining a vibrational dental device configured to vibrate at a frequency between about 20 Hz and about 250 Hz, such as at a frequency higher than about 80 Hz. The method may further include mechanically vibrating, using the vibrational dental device, a tooth at the extraction site for about a predetermined period of time daily for a treatment period before extracting the tooth. The treatment period may be about 14 days or fewer. The mechanical vibration may prepare the extraction site to be in a healthier condition for receiving an implant.

According to another exemplary embodiment of the present disclosure, a method for dental implantation is described. The method may include obtaining a vibrational dental device configured to vibrate at a frequency between about 20 Hz and about 250 Hz, such as at a frequency higher than about 80 Hz. The method may also include mechanically vibrating, using the vibrational dental device, a tooth at the extraction site for about a predetermined period of time daily for a treatment period before extracting the tooth. The method may further include extracting the tooth and placing an implant at the extraction site after the tooth extraction. The mechanical vibration may prepare the extraction site to be in a healthier condition for receiving an implant.

In some embodiments, the predetermined period of time may be about 20 minutes daily or less than about 20 minutes daily, such as 15 minutes daily, 10 minutes daily, 6 minutes daily, 5 minutes daily, 4 minutes daily, or less. It is contemplated that in other embodiments the predetermined period of time may be any value within the range of about 1 minute and 19 minutes daily, and that the daily total treatment time could be formed of a plurality of treatment sessions contributing to the daily total treatment time. In one exemplary embodiment, the daily total treatment time is about 5 minutes.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims. It is to be understood that both the foregoing general description and the following detailed description are examples and explanatory only and are not restrictive of the disclosed embodiments as claimed.

The accompanying drawings constitute a part of this specification. The drawings illustrate several embodiments of the present disclosure and, together with the description, serve to explain the principles of the disclosed embodiments as set forth in the accompanying claims.

### BRIEF DESCRIPTION OF THE DRAWINGS

FIG. 1A is a perspective view of an exemplary vibrational dental device, according to embodiments of the present disclosure.

FIG. 1B is a partial perspective view of the exemplary vibrational dental device of FIG. 1A, according to embodiments of the present disclosure.

FIG. 1C is a component view of the exemplary vibrational dental device of FIG. 1A, according to embodiments of the present disclosure.

FIG. 2 illustrates an operation of the exemplary vibrational dental device of FIG. 1.

### DETAILED DESCRIPTION

The disclosed embodiments relate to apparatuses and methods for pre-conditioning dentition extraction site for implantation. Advantageously, embodiments of the present disclosure can be implemented before tooth extraction to achieve better results of implantation at the extraction site.

It is hypothesized that the bone and soft tissue around a dentition extraction site to be placed with the implant may be prepared to be in healthier conditions before tooth extraction to achieve better results of implantation, contrary to the suggestion that extraction of a more freely set tooth may lead to better results. In some instances, healthier bone and soft tissue around the extraction site may reduce the overall implantation treatment period by obviating the need for bone augmentation or bone grafting. Also, healthier bone and soft tissue around the extraction site may reduce the overall implantation treatment period by expediting the healing process, for example, by allowing for faster bone healing, faster soft tissue healing, and/or faster bonding of the implant to the bone, i.e., osseointegration. In some instances, healthier bone and soft tissue around the extraction site may increase the survival rate of the implant.

It is further hypothesized that mechanical vibration with certain pre-determined variables, such as frequency, g-force or acceleration magnitude, and duration, may be used to pre-condition a dentition extraction site before tooth extraction to achieve better results of dental implantation.

According to an aspect of the present disclosure, mechanical vibration may be applied to a tooth in an extraction site before tooth extraction. In some embodiments, the mechanical vibration may be further applied to the bone and soft tissue around the extraction site via the tooth and increase vascularity and blood circulation in the soft tissue, such as in the periodontal ligament (PDL), around the extraction site. The increased vascularity and blood circulation associated with mechanical vibration may prepare the soft tissue around the extraction site to be in a healthier condition for receiving the implant. In some embodiments, the mechanical vibration may stimulate the activity of periodontal ligament fibroblasts and generate new PDL fiber attachments for supporting the implant to be received in the extraction site.

In some embodiments, the mechanical stimulation may stimulate bone formation around the extraction site, increasing the amount of bone for supporting or holding the implant to be placed in the extraction site. In some embodiments, the mechanical vibration may increase the bone density around the extraction site, increasing the strength of the bone for holding the implant to be placed in the extraction site. For example, the mechanical vibration may stimulate osteoblastic activity and induce proliferation of osteoblasts in the alveolar bone, thereby stimulating alveolar bone formation and remodeling around the tooth to be extracted. The alveolar bone regeneration and remodeling may in turn prepare the extraction site to be in a healthier condition for receiving and supporting the implant, notwithstanding the additional trauma from the extraction of a set tooth. In some instances, the mechanical vibration may increase the mineral density of the alveolar bone around the extraction site. For example, the mechanical vibration may stimulate the expression of mineralization proteins in the alveolar bone around the extraction site, thereby increasing the alveolar bone mineral density and strength for supporting the implant to be received in the extraction site. In some instances, the mechanical vibration may stimulate the activity of periodontal ligament fibroblasts and induce its proliferation and differentiation into osteoblasts, which may generate new alveolar bone or cause remodeling of alveolar bone, thereby preparing the extraction site to be in a healthier condition for receiving and supporting the implant.

In some embodiments, the mechanical vibration may prepare the bone around the extraction site to be in a healthier condition to achieve faster osseointegration after the implant is placed in the extraction site. For example, mechanical vibration may increase vascularity and blood circulation in the soft tissue around the extraction site, which may allow for faster bone growth and/or faster soft tissue healing around the implant. Additionally, the mechanical vibration may increase osteoblastic activity around the extraction site, which may further allow for faster bone growth around the implant. Such expedited osseointegration due to the mechanical vibration may in turn reduce the healing period after the implant is placed in the extraction site, thereby reducing the overall implantation treatment period and amount of discomfort of the patient.

According to an aspect of the present disclosure, a vibrational dental device that vibrates at a frequency between about 20 Hz and about 250 Hz, such as at a frequency higher than about 80 Hz is provided. The vibrational dental device includes a mouthpiece and a motor connected to the mouthpiece. The mouthpiece is configured to be provided between the occlusal surfaces of a user's teeth so as to be clamped by the user's teeth. The motor is configured to vibrate the mouthpiece at a frequency between about 20 Hz and about 250 Hz, such as at a frequency higher than about 80 Hz, such as at a frequency between about 100 Hz to about 120 Hz, and with an acceleration magnitude ranging between about 0.01 G and about 1 G, such as between about 0.03 G and about 0.2 G. When the motor is in operation and when the mouthpiece is clamped between the occlusal surfaces of a user's teeth, the vibrational dental device applies an axial vibratory force on the occlusal surfaces. Advantageously, mechanical vibration applied to an extraction site of a patient using the vibrational device prepares the extraction site in a healthier condition for receiving an implant, allowing for better results of implantation at the extraction site.

In some embodiments, the vibrational dental device may further include a sensor configured to detect the vibration variables of the device, such as frequency and acceleration magnitude. When the mouthpiece of the vibrational dental device is clamped between the occlusal surfaces of a user's teeth, the sensor may detect the vibration variables proximate to the occlusal surfaces of the user's teeth. In some embodiments, the sensor is a piezoelectric sensor.

According to another aspect of the present disclosure, a method for pre-conditioning an extraction site for receiving an implant is provided. The method includes mechanically vibrating, using an exemplary vibrational dental device, the bone and/or soft tissue around the extraction site for about 20 minutes or less, for example for about 5 minutes, daily at a frequency between about 20 Hz and about 250 Hz, such as at a frequency higher than about 80 Hz over a treatment period. The method may further include mechanically stimulating cells in the PDL around the extraction site. The cells may include at least one of human osteoblasts and fibroblasts. The treatment period may extend for about a couple of days to a few days, about a couple of weeks to a few weeks, or up to about a few months, at the end of which, the number of the cells increases. In some embodiments, at the end of the treatment period, the osteoblastic activity around the extraction site is increased. As a non-limiting example, at the end of the treatment period, the alveolar bone around the extraction site are strengthened and/or remodeled. As a further non-limiting example, at the end of the treatment period, new alveolar bone around the extraction site are formed.

According to another aspect of the present disclosure, a method for pre-conditioning an extraction site for receiving an implant is described. The method includes providing the mouthpiece of the vibrational dental device between the occlusal surfaces of the patient's teeth to be clamped by the patient's teeth. The method further includes mechanically vibrating, using the vibrational dental device, the teeth of the patient, for about 20 minutes or less, for example for about 5 minutes, at a frequency between about 20 Hz and about 250 Hz, such as at a frequency higher than 80 Hz daily over a treatment period, such as about a couple of days to a few days, about a couple of weeks to a few weeks, or up to about a few months. In some embodiments, the method includes increasing vascularity and circulation in the PDL around the extraction site at the end of the treatment period, thereby pre-conditioning the extraction site for receiving an implant. In some embodiments, the method include stimulating the activity of periodontal ligament fibroblasts to generate new PDL fiber attachments for supporting the implant to be received in the extraction site.

According to another aspect of the present disclosure, a method for pre-conditioning an extraction site for receiving an implant is described. The method includes providing the mouthpiece of the vibrational dental device between the occlusal surfaces of the patient's teeth to be clamped by the patient's teeth. The method further includes mechanically vibrating, using the vibrational dental device, the teeth of the patient, for about 20 minutes or less, for example for about 5 minutes, at a frequency between about 20 Hz and about 250 Hz, such as at a frequency higher than 80 Hz daily over a treatment period, such as about a couple of days to a few days, about a couple of weeks to a few weeks, or up to about a few months. In some embodiments, the method includes increasing vascularity and circulation in the PDL and/or increasing osteoblastic activity around the extraction site at the end of the treatment period, thereby preparing the extraction site to be in a healthier condition for osseointegration after the implant is placed in the extraction site.

In some embodiments, the method further includes applying an axial vibratory force on the occlusal surfaces by the vibrational dental device. In some embodiments, the vibrational frequency and/or the acceleration magnitude generated by the vibrational dental device may be adjusted. Such adjustment may depend on one or more factors, such as the speed of tooth movement, the patient's reported comfort level, the extent of root resorption, the degree of dentition looseness, and/or the patient's compliance level.

Reference will now be made in detail to embodiments and aspects of the present disclosure, examples of which are illustrated in the accompanying drawings. Where possible, the same reference numbers will be used throughout the drawings to refer to the same or like parts.

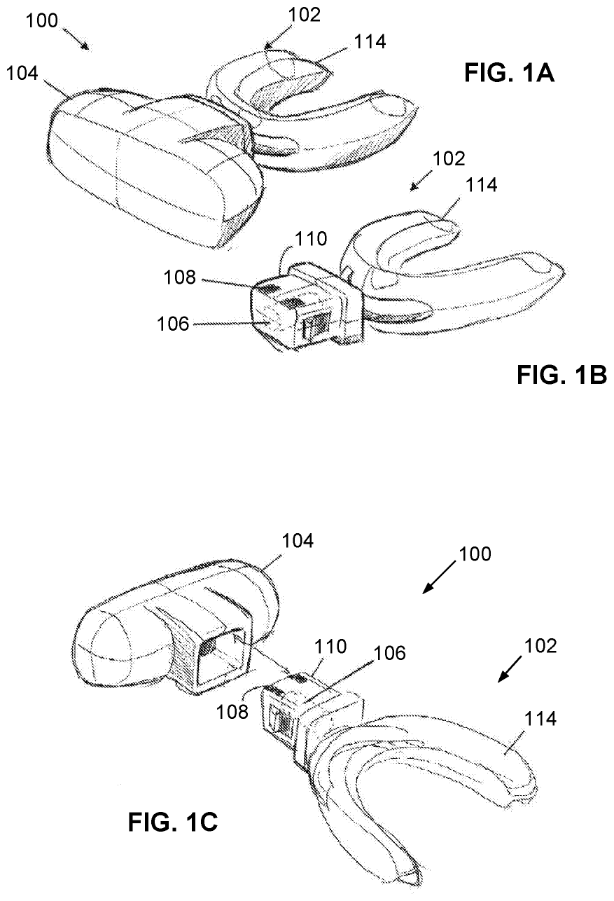

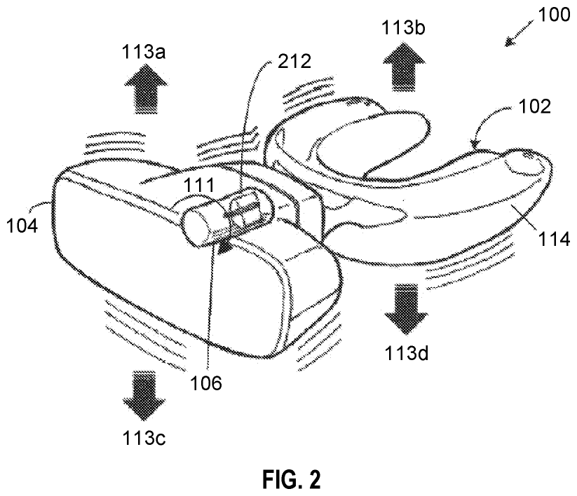

FIG. 1A is a perspective view of an exemplary vibrational dental device 100. FIG. 1B is a partial perspective view of vibrational dental device 100. FIG. 1C is a component view of vibrational dental device 100. As shown in FIGS. 1A-1C, vibrational dental device 100 includes a mouthpiece 102, a base 104, and a motor 106. Mouthpiece 102 is removably attached to base 104. Mouthpiece 102 includes a biteplate 114 and a mouthpiece extension 110 configured to connect with base 104. In some embodiments, mouthpiece 102 and/or biteplate 114 can be configured to engage some or all of a user's teeth. For example, in the exemplary embodiments shown in FIGS. 1A-2, mouthpiece 102 and/or biteplate 114 are shaped to engage some or all of a user's teeth. The mouthpiece can be made to apply mechanical vibration directly to a user's teeth, or to orthodontic aligners or other orthodontic appliances applied to the teeth. Extension 110 may further include contacts 108 that electrically connect base 104 with motor 106.

As described herein, the shape of mouthpiece 102 and/or biteplate 114 shown in FIGS. 1A-2 is only exemplary. Mouthpiece 102 and/or biteplate 114 may have a U-shape or a C-shape as depicted, or a customized shape suitable for safe application of vibrational treatment to all or some of a user's teeth, or even a single tooth, and/or sitting against an orthodontic aligner on the user's teeth. In some embodiments, mouthpiece 102 and/or biteplate 114 may have any suitable shape to sit against the occlusal surface, the labial surface, or the lingual surface of the user's teeth or an orthodontic aligner over the user's teeth. In some embodiments, biteplate 114 may have surface textural and topographical variations, such as ridges, corresponding to surface variations of the occlusal surface of the user's teeth or an orthodontic aligner over the user's teeth. As a non-limiting example, mouthpiece 102 and/or biteplate 114 can have any suitable shape or surface texture to contact all or selected occlusal surfaces of the user's teeth or an orthodontic aligner over the user's teeth.

As shown in FIGS. 1B and 1C, motor 106 is installed in extension 110 of mouthpiece 102. When mouthpiece 102 is attached to base 104, motor 106 resides in base 104. Base 104 further includes electronic circuitries (not shown), including a control circuitry and a power circuitry, for operating motor 106. Motor 106 may be any type of motor that can cause mouthpiece 102 or biteplate 114 to vibrate. For example, motor 106 could be a vibration motor, piezoelectric motor, a linear motor, or an electromagnetic motor. The frequency and/or strength of vibration caused by motor 106 can be adjusted by changing the voltage or current supplied to motor 106 by the electronic circuitries in base 104. For example, the voltage used for operating motor 106 may range from about 0.5 volt to about 4 volts. The current supplied to an exemplary motor 106 may range from about 65 mA to about 100 mA.

Motor 106 may have any suitable mechanical configurations to cause mouthpiece 102 or biteplate 114 to vibrate axially. FIG. 2 illustrates an exemplary operation of vibrational dental device 100. As shown in FIG. 2, in one embodiment, motor 106 is a counter-weighted motor with a longitudinal axis parallel to the longitudinal axis of extension 110. Motor 106 may include a counterweight 212 that is off-axis from the longitudinal axis of motor 106. In an exemplary embodiment, when the motor 106 rotates, as shown by the arrow 111 in FIG. 2, counterweight 212 moves up and down, causing the mouthpiece 102 to vibrate up and down, as shown by the arrows 113a-113d in FIG. 2. The vibrator can be arranged to create vibration in two or three axes. Accordingly, when the exemplary mouthpiece 102 is placed between a user's teeth, and when exemplary vibrational dental device 100 is turned on, the vibration of mouthpiece 102 will apply a vibratory force on the occlusal surfaces of the teeth. For example, biteplate 114 of mouthpiece 102 in an exemplary embodiment may cyclically move axially between the occlusal surfaces of the teeth. In other embodiments, the biteplate 114 of mouthpiece 102 may cyclically move in one or more of the three spatial axes.

In some embodiments, vibrational dental device 100 may further include one or more sensors (not shown), such as piezoelectric sensors, configured to detect the acceleration magnitude and/or frequency of the vibration of mouthpiece 102. For example, sensors may be placed on the outside or the inside edge of biteplate 114, proximate to the occlusal surfaces of the teeth when mouthpiece 102 is clamped between the occlusal surfaces. The sensors can be electrically connected to the electronic circuitries in base 104. Measurements of the sensors can be fed back to the control circuitry of motor 106 to adjust the acceleration magnitude and/or frequency of motor 106. For example, the detected acceleration magnitude and/or frequency may be compared to a desired acceleration magnitude and/or frequency, and the voltage and/or current supplied to motor 106 can be adjusted based on the comparison.

In some embodiments, motor 106 is configured to vibrate mouthpiece 102 at a frequency between about 20 Hz and about 250 Hz, such as at a frequency higher than 80 Hz, between about 120 Hz to about 130 Hz, between about 110 Hz to about 120 Hz, between about 100 Hz to about 110 Hz, between about 90 Hz to about 100 Hz, between about 80 Hz to about 90 Hz, between about 80 Hz to about 100 Hz, between about 90 Hz to about 110 Hz, between about 100 Hz to about 120 Hz, between about 110 Hz to about 130 Hz, between about 120 Hz to about 140 Hz, between about 100 Hz to about 140 Hz, between about 120 Hz to about 160 Hz, between about 140 Hz to about 180 Hz, between about 160 Hz to about 200 Hz, between about 180 Hz to about 120 Hz, or between about 200 Hz to about 250 Hz, and more specifically at a frequency at or about 100 Hz or 120 Hz. Motor 106 may be further configured to vibrate mouthpiece 102 at an acceleration magnitude ranging between about 0.01 G and about 1 G, such as between about 0.03 G and about 0.2 G.

As described herein, the vibrational frequency of mouthpiece 120 may vary from the rated “free-air” vibrational frequency of motor 106 due to the amount of biting force or load applied to mouthpiece 102, such as the force used to clamp vibrational dental device 100 in place. For example, when motor 106 is configured to vibrate at a frequency of or about 120 Hz, adding biting force or load to mouthpiece 102 may result in a lower vibrational frequency of mouthpiece 102 ranging from about 100 Hz to about 120 Hz.

In some embodiments, vibrational dental device 100 can be used for applying mechanical vibration to all or some of a patient's teeth for a daily treatment period. The daily treatment period can be, for example, about 20 minutes or less, such as 15 minutes, 10 minutes, 6 minutes, 5 minutes, 4 minutes, or less. It is contemplated that in other embodiments the treatment period could be any value within the range of about 1 minute and 19 minutes daily, and that the daily total treatment period could be formed of a plurality of treatment sessions contributing to the daily total treatment period. In some embodiments, vibrational treatment of a patient's teeth may be applied over a period for pre-conditioning the extraction site before tooth extraction, such as a period over about any number of days fewer than 14 days, or about any number of days between 14 days to about 30 days, or any number of days between about 1 month to a few months.

Examples 1-4 described below illustrate the use of vibrational dental device 100 operating under the variables described above and its clinically relevant effects.

### Example 1

An exemplary embodiment of vibrational dental device 100 is used to mechanically stimulate periodontal cells around an extraction site to be placed with an implant for a treatment period before a tooth in the extraction site is extracted. The periodontal cells include human osteoblasts in alveolar bone and periodontal ligament fibroblasts. The periodontal cells are mechanically stimulated for about 20 minutes or less, for example for about 5 minutes, at a frequency from about 20 Hz to about 250 Hz, for example from about 100 Hz to about 120 Hz, daily over a treatment period, which lasts for about a couple of days to a couple of weeks, such as about 7 days. At the end of the treatment period, the number of periodontal cells, including osteoblasts in alveolar bone and periodontal ligament fibroblasts around the extraction site, is increased. The tooth in the extraction site is then extracted, after which an implant is placed in the extraction site using suitable surgical procedures.

### Example 2

An exemplary embodiment of vibrational dental device 100 is used to treat an extraction site to be placed with an implant for a treatment period before tooth extraction. Vibrational dental device 100 is used to mechanically vibrate bone and soft tissue around the extraction site for about 20 minutes or less, for example for about 5 minutes, at a frequency from about 20 Hz to about 250 Hz, for example from about 100 Hz to about 120 Hz, daily over a period of time, which lasts for about a couple of days to a couple of weeks, such as about 7 days. At the end of the treatment period, the alveolar bone and PDL fiber attachments around the extraction site are regenerated, causing regeneration and remodeling of alveolar bone and PDL around the extraction site. The tooth in the extraction site is then extracted, after which an implant is placed in the extraction site using suitable surgical procedures.

### Example 3

An exemplary embodiment of vibrational dental device 100 is used to treat an extraction site to be placed with an implant for a treatment period before tooth extraction. Vibrational dental device 100 is used to mechanically vibrate a tooth in the extraction site for about 20 minutes or less, for example for about 5 minutes, at a frequency from about 20 Hz to about 250 Hz, for example from about 100 Hz to about 120 Hz, daily over a period of time, which lasts for about a couple of days to a couple of weeks, such as about 7 days. Mechanical vibration is also applied to the bone and soft tissue around the extraction site via the tooth in the extraction site. At the end of the treatment period, vascularity and circulation in the PDL around the extraction site is increased. The tooth in the extraction site is then extracted, after which an implant is placed in the extraction site using suitable surgical procedures.

### Example 4

An exemplary embodiment of vibrational dental device 100 is used to pre-condition an extraction site to be placed with an implant for a treatment period before tooth extraction. Vibrational dental device 100 is used to mechanically vibrate a tooth in the extraction site for about 20 minutes or less, for example for about 5 minutes, at a frequency from about 20 Hz to about 250 Hz, for example from about 100 Hz to about 120 Hz, daily over a period of time, which lasts for about a couple of days to a couple of weeks, such as about 7 days. At the end of the treatment period, the bone and soft tissue around the extraction site are in healthier conditions for receiving the implant. The tooth in the extraction site is then extracted, after which an implant is placed in the extraction site using suitable surgical procedures.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A method for pre-conditioning an extraction site for dental implantation, the method comprising:
providing a vibrational dental device configured to vibrate at a frequency higher than about 20 Hz; and
providing instructions for mechanically vibrating, using the vibrational dental device, a tooth at the extraction site for about 20 minutes or less daily over a treatment period before extracting the tooth;
wherein the mechanical vibration prepares the extraction site to be in a healthier condition for receiving an implant.

2. The method of claim 1, further comprising mechanically vibrating bone and soft tissue around the extraction site.

3. The method of claim 2, wherein the mechanical vibration stimulates growth of periodontal cells, including at least one of human osteoblasts and fibroblasts, around the extraction site.

4. The method of claim 2, wherein the mechanical vibration causes regeneration and remodeling of alveolar bone around the extraction site.

5. The method of claim 2, wherein the mechanical vibration increases vascularity and blood circulation in the soft tissue around the extraction site.

6. The method of claim 2, wherein the mechanical vibration increases activity of least one of human osteoblasts and fibroblasts around the extraction site.

7. The method of claim 1, wherein the vibrational dental device is configured to vibrate at an acceleration magnitude ranging between about 0.01 G and about 1 G.

8. The method of claim 1, the vibrational dental device is configured to vibrate at a frequency between about 20 Hz and about 250 Hz.

9. The method of claim 1, wherein the vibrational dental device comprises a mouthpiece and a motor connected to and configured to vibrate the mouthpiece.

10. The method of claim 9, further comprising detecting vibration characteristics of the mouthpiece.

11. A method for pre-conditioning an extraction site for dental implantation, the method comprising:
obtaining a vibrational dental device configured to vibrate at a frequency higher than about 20 Hz; and
mechanically vibrating, using the vibrational dental device, a tooth at the extraction site for about 20 minutes or less daily for a treatment period before extracting the tooth;
wherein the mechanical vibration prepares the extraction site to be in a healthier condition for receiving an implant.

12. The method of claim 11, further comprising mechanically vibrating bone and soft tissue around the extraction site.

13. The method of claim 12, wherein the mechanical vibration stimulates growth of periodontal cells, including at least one of human osteoblasts and fibroblasts, around the extraction site.

14. The method of claim 12, wherein the mechanical vibration causes regeneration and remodeling of alveolar bone around the extraction site.

15. The method of claim 12, wherein the mechanical vibration increases vascularity and blood circulation in the soft tissue around the extraction site.

16. The method of claim 12, wherein the mechanical vibration increases activity of least one of human osteoblasts and fibroblasts around the extraction site.

17. The method of claim 11, wherein the vibrational dental device is configured to vibrate at an acceleration magnitude ranging between about 0.01 G and about 1 G.

18. The method of claim 11, the vibrational dental device is configured to vibrate at a frequency between about 20 Hz and about 250 Hz.

19. The method of claim 11, wherein the vibrational dental device comprises a mouthpiece and a motor connected to and configured to vibrate the mouthpiece.

20. The method of claim 19, further comprising detecting vibration characteristics of the mouthpiece.

21. A method for dental implantation, the method comprising:
obtaining a vibrational dental device configured to vibrate at a frequency higher than about 20 Hz; and
mechanically vibrating, using the vibrational dental device, a tooth at an extraction site for about 20 minutes or less daily for a treatment period before extracting the tooth;
extracting the tooth;
placing an implant at the extraction site;
wherein the mechanical vibration prepares the extraction site to be in a healthier condition for receiving the implant.
